(19) United States
(12) Patent Application Publication
(10) Pub. No.: US 2018/0176027 A1
(43) Pub. Date: Jun. 21, 2018

(54) MECHANISM FOR ESTIMATED OVER-THE-TOP (OTT) MEDIA STREAMING DATA USAGE AND DATA RATE NOTIFICATION

(71) Applicant: ARRIS Enterprises LLC, Suwanee, CA (US)

(72) Inventors: Christopher S. DelSordo, Souderton, PA (US); Albert F. Elcock, West Chester, PA (US); Charles Hardt, Lawrenceville, PA (US)

(21) Appl. No.: 15/384,113

(22) Filed: Dec. 19, 2016

(51) Int. Cl. H04L 12/14; H04L 29/06; H04M 15/00

(52) U.S. Cl. CPC H04L 12/1435; H04L 65/4092; H04L 12/1403; H04M 15/8351; H04M 15/58; H04M 15/858; H04L 65/4084

(57) ABSTRACT

Systems and methods obtain, prior to streaming an over the top (OTT) multimedia asset, meta-data associated with the multimedia asset. The metadata includes a duration of the multimedia asset and a data rate at which the asset is provided. The systems and methods estimates, based on the meta-data, an amount of data usage resulting from use of the one data rate at which the multimedia asset is provided. The user is them prompted to indicate whether to stream the multimedia asset, and upon receipt of an indication to stream the multimedia asset, the multimedia asset is streamed.

### TECHNICAL FIELD

The present disclosure relates to the field of multimedia streaming, and more particularly, to a mechanism for calculating and providing estimated over-the-top (OTT) media streaming data usage and data rate notification.

### BACKGROUND

There has been a significant increase in viewing over-the-top (OTT) media content recently and this trend will continue for the foreseeable future. Over-the-top (OTT) media is media (video, audio and/or text messages) that are delivered over the Internet® with or without the involvement of a multiple service provider (MSO) such as a cable, satellite, or telephone company, in the control or distribution of the media content. Delivery of OTT content has become increasingly popular with the advent of Internet streaming services such as Netflix®, Hulu® and YouTube®. Beyond the subscription fees for these services, there may also be a cost to the consumer in terms of data charges or bandwidth limitations. It is difficult, however, for a consumer of the OTT media content to determine these costs for these streaming sessions.

### SUMMARY

The present disclosure describes systems and methods which utilize a mechanism for calculating and providing estimated OTT media streaming data usage and data rate notification.

One example method includes obtaining, prior to streaming a multimedia asset, meta-data associated with the multimedia asset, estimating, based on the meta-data, an amount of data usage resulting from use of at least one data rate available for streaming the multimedia asset, prompting a user to indicate whether to stream the multimedia asset, and upon receipt of an indication to stream the multimedia asset, streaming the multimedia asset.

One example system includes a receiver, a computer memory, and a processor in communication with the receiver and the computer memory. The processor is programmed to obtain, prior to streaming a multimedia asset, meta-data associated with the multimedia asset and estimate, based on the meta-data, an amount of data usage resulting from use of at least one data rate available for streaming the multimedia asset. The process is also programmed to prompt a user to indicate whether to stream the multimedia asset and upon receipt of an indication to stream the multimedia asset, stream the multimedia asset.

### BRIEF DESCRIPTION OF THE DRAWINGS

Further details of the example implementations are explained with the help of the attached drawings in which:

FIG. 1A depicts a block diagram of an example of a system which may utilize a mechanism to calculate and provide estimated OTT media streaming data usage and data rate notification.

FIG. 1B depicts a block diagram of another example of a system which may utilize the mechanism to calculate and provide estimated OTT media streaming data usage and data rate notification.

FIG. 2 depicts a flowchart of an example process utilized by a mechanism for estimated OTT media streaming data usage and data rate notification.

FIG. 3 depicts an example of an output display which may provide a non-adaptive data rate notification screen.

FIG. 4 depicts an example of an output display which may provide an adaptive data rate notification screen with configuration capability.

FIG. 5 is a block diagram of an example mobile device usable in the examples illustrated in FIGS. 1A and 1B.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

The example systems and methods described below implement a mechanism for estimated OTT media streaming data usage and data rate notification. OTT media is typically compressed and transmitted according to a streaming protocol used by the provider. Example streaming protocols including RTSP, RTP, IGMP, multicast, Flash™ Player technology, Silverlight® Player technology, Apple® HLS, with advanced MPEG2, H.264, AAC, MPEG DASH, and related audio/video CODECs. Currently, a consumer of OTT media streaming is unable to determine a cost of streaming the OTT media content in order to determine whether the OTT media content should be consumed. For example, a consumer may have limited data usage available via a cellular wireless data plan. In another example, a consumer may have limited bandwidth available within a Wi-Fi network environment (e.g., an additional stream of OTT media content may have a negative impact on an existing stream of OTT media content). Therefore, a mechanism is needed in order to provide the consumer with the necessary information to make an informed decision regarding whether or not and how to stream OTT media content.

In one example, estimated data usage by OTT media content is provided to a consumer. Alternatively, or in addition, an indication of data rates supported by OTT media content is provided the consumer. The consumer, in turn, may decide whether or not to stream the OTT media content and/or select one or more supported data rates to be enabled for streaming the OTT media content. For example, a consumer wants to stream a particular OTT media content asset. In this example, the OTT media content asset is 30 minutes in duration and has a bit rate of 3 Mbps. Although a bit rate is used in the examples below, the term should be interpreted to include other measures of rates of data transfer (data rates). The estimated data usage to stream this OTT media content is, therefore, 675 MB. The consumer, in this example, may only have 500 MB of available data usage remaining, in which case the consumer may either forego streaming the content or pay for additional data usage.

In another example, a home or other location has a Wi-Fi or other wireless network available over which OTT media content is streamed. While one user is actively streaming a first OTT media content asset, a second user may desire to stream a second OTT media content asset. Upon indication of various maximum bit rates supported by the second OTT media content asset, the second user may elect to enable or otherwise select only those maximum bit rates that will not negatively impact streaming of the first OTT media content asset. Other criteria for selection of which bit rate(s) is/are to be utilized for streaming a media content include, for example, differing costs for each bit rate, download speed for each bit rate and/or media quality of each bit rate.

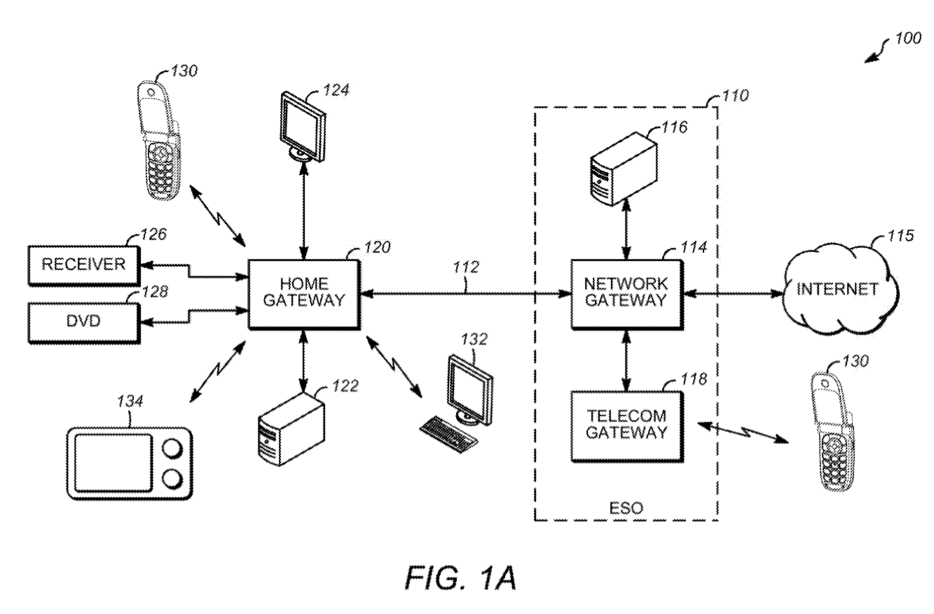

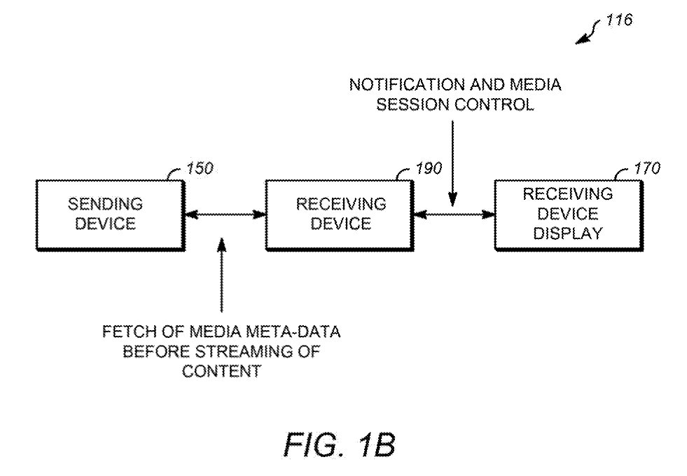

FIG. 1A depicts an embodiment of a system 100 which utilizes or otherwise implements a mechanism for estimated OTT media streaming data usage and data rate notification. System 100 is, for example, part of a communications network that can be used as a broadcast, ATSC, IPTV or IP Video delivery network that transports or delivers data files and multimedia content, including via multicast transmissions. The network environment can include an edge serving office (ESO) 110, which can be a head-end or central office of a multiple service provider (MSO) such as a cable, satellite, or telephone company. The ESO 110 can contain various communications equipment, such as one or more modulation/demodulation devices (not shown), a content server (not shown), and other communications equipment (not shown) that can provide video, data, and/or voice service to a user.

The communications equipment at the ESO 110 is operable to communicate with a home gateway 120 using a cable line network connection 112. In one example, the home gateway 120 includes the functionality of a set-top box (STB). The combination of the STB and the home gateway may be referred to as a set-top gateway. It is contemplated, however, that the STB may be separate from the home gateway. In this instance, the home gateway provides the network connection and the STB provides the media functionality. When the STB is separate from the home gateway 120, the STB may be connected to network connection 112 in parallel with the home gateway or may be connected to the home gateway 120 to receive IPTV packets from ESO 110 via the home gateway.

The communications equipment at the ESO 110 can be operable to communicate with one or more user devices through home gateway 120. The user devices may be customer premises equipment (CPE) devices such as a network attached storage (NAS) device 122, a digital television (DTV) receiver 124, a radio receiver 126, a digital video disc (DVD) player 128 including a streaming video facility, a mobile device 130, a computer 132 or a thermostat 134 or other Internet of things (IoT) device (e.g. an appliance, surveillance camera, light fixture, etc.) that connects to the Internet through the home gateway. These CPE devices can be located at or near a user's premises. In the example system, CPE device 130 is a mobile device that may have wireless telecommunications capability, even though it is designated as a “customer premise” device. In FIG. 1A, only particular CPE devices 122, 124, 126, 128, 130, 132, and 134 are shown for illustrative purposes, but more or fewer can be coupled to the ESO 110 via the home gateway 120.

Still referring to FIG. 1A, the communications equipment at the ESO 110 can communicate with one or more of the CPE devices 122, 124, 126, 128, 130, 132, and 134 through a transport network. Examples of ESO-to-Premises transport networks include one or more hybrid-fiber coaxial (HFC) networks and/or RF over Glass (RFoG) networks. An example HFC network can use a combination of optical fibers and coaxial cable as the network connection 112 to send data to and receive data from the communications equipment at the ESO 110. One or more RFoG networks can be deployed with existing HFC networks. RFoG networks typically include an all-fiber service from the ESO 110 to a field node, or home gateway 120, which is typically located at or near the user's premises. Coaxial cable can be used to connect the optical network units (ONUs) of an RFoG network to one or more user devices 122, 124, 126, 128, 130, 132, and 134. Additionally, any other wired or wireless networks can be used, including Passive Optical Networks (PON), Gigabit Passive Optical Networks (GPON), Digital Subscriber Line (DSL), Wi-MAX, or Ethernet.

In this example, the NAS device 122, DTV receiver 124, and radio receiver 126 may be coupled to the home gateway 120 via physical connections. The mobile device 130 may be coupled to the gateway 120 via a short-range radio frequency (RF), magnetic or optical connection (e.g. 802.11 WiFi, Bluetooth, Zigbee Radio Frequency for Consumer Electronics (RF4CE), near field communication (NFC) or infra-red (IR)), and the computer 132, thermostat 134 and DVD player 128, may be coupled to the home gateway 120 via a wired connection such as a universal serial bus (USB) cable, a FireWire cable, an Ethernet connection and/or via a short-range RF, magnetic or optical wireless connection. Each of these connections may be considered to be a separate communications channel.

The ESO 110 includes a network gateway 114 that provides access between a network and a data processing server 116 and, optionally to other networks, such as the Internet, and a telecommunications gateway 118 that provides telecommunications access to CPE devices such as mobile device 130 that is also coupled to the home gateway 120 via the short-range RF, magnetic or optical connection. The ESO 110 may include data sources (not shown), that provide content to the CPE devices via a standard cable television connection or as an IPTV or IP Video delivery network. These data sources, for example, may be servers coupled to the network gateway 114 in the same manner as the data processing server 116.

FIG. 1B depicts an example of another system which utilizes or otherwise implements a mechanism for estimated OTT media streaming data usage and data rate notification. System 116 is, for example, also part of a communications network, although the details of such communications network are not explicitly shown. The communications network of FIG. 1B may be similar to that of FIG. 1A and/or may include other networking functionality, such as cellular wireless data and/or telephony services. As can be seen in FIG. 1B, sending device 150 receives requests from and delivers responses to receiving device 190. Sending device 150 is, for example, a server computer or other content repository. Alternatively, or in addition, sending device 150 is a client computer which has previously acquired content from another source.

Receiving device 190 is, for example, a client computer that includes receiving device display 170. For example, receiving device 190 is a mobile device such as a mobile phone, a tablet, a laptop or notebook computer. Alternatively, receiving device 190 is a “fixed” device such as a desktop computer, a digital television, a smart television or other smart appliance. As shown in FIG. 1B and described in greater detail below, receiving device display 170 is utilized for notification and media session control. Furthermore, receiving device 190 retrieves meta-data associated with OTT media content from sending device 150 prior to streaming of the OTT media content.

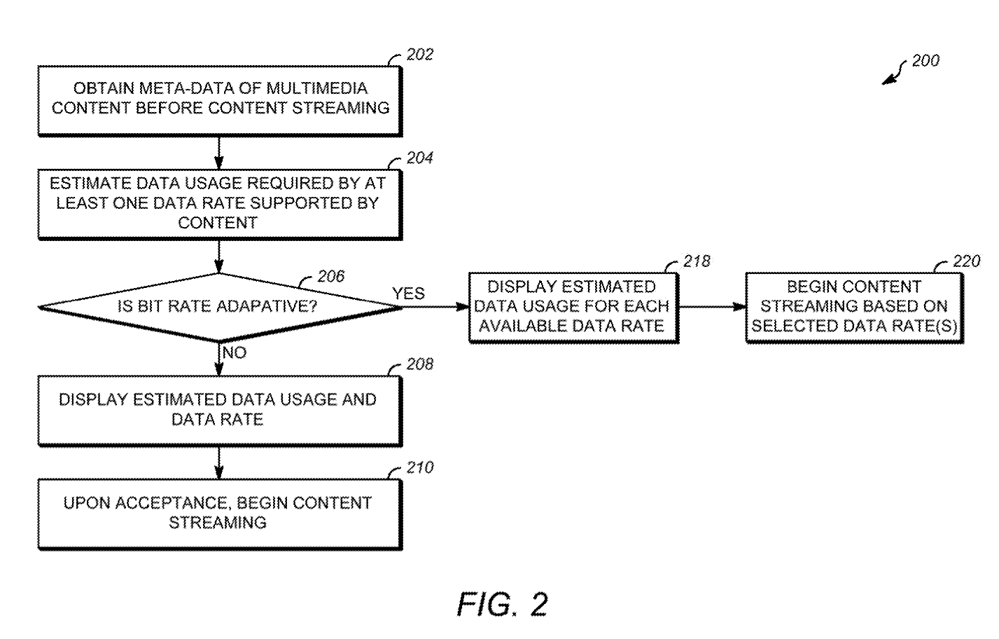

FIG. 2 depicts an example of a method 200 for calculating and providing estimated OTT media streaming data usage and data rate notification. Generally, method 200 includes obtaining meta-data of multimedia content prior to streaming the content, estimating data usage by at least one data rate supported by the content, displaying one or more estimates of data usage, and, based on user input, and streaming the content. Additional details of method 200 are set forth below, and may be described with respect to the components of system 100 and system 116.

In step 202, meta-data associated with OTT media content is obtained. In general, meta-data is additional data associated with OTT media content that describes the media content. The obtained meta-data includes, for example, an indication of the duration of the media content, an indication of one or more bit rates supported by the media content, an indication of one or more formats supported by the media content, and other information describing the media content. In one example, the meta-data includes separate video information (e.g., video duration, video bit rate(s), video formats, etc.) and separate audio information (e.g., audio duration, audio bit rate(s), audio formats, etc.). Of note, OTT media content may be available in a non-adaptive bit rate package such that the media content supports a fixed format and a fixed bit rate. Alternatively, or in addition, the media content may be available in an adaptive bit rate package such that the media content supports various formats and various bit rates.

Data usage resulting from use of at least one data rate supported by the OTT media content is estimated in step 204. For example, given a non-adaptive bit rate media content, the estimated data usage to stream the media content is calculated as the duration of the media multiplied by the bit rate of the content. Given, in an alternate example, an adaptive bit rate media content (e.g., a multimedia asset that utilizes one or more different bit rates), multiple estimates of data usage may be calculated based on each supported bit rate. In this alternate example, each estimate is calculated as the duration of the media multiplied by the respective supported bit rate. In one example, an estimate of data usage is calculated for the media content as a whole. Alternatively, or in addition, an estimate of data usage to stream a video portion of the media content is calculated and an estimate of data usage to stream an audio portion of the media content is calculated.

A determination, in step 206, is made as to whether the media content supports an adaptive bit rate. Although this determination is depicted as following step 204, this is only for simplicity in depicting the process flow. Alternatively, the determination may be made prior to step 204. In either case, the determination is made because information displayed for non-adaptive bit rate content will be different from information displayed for adaptive bit rate content.

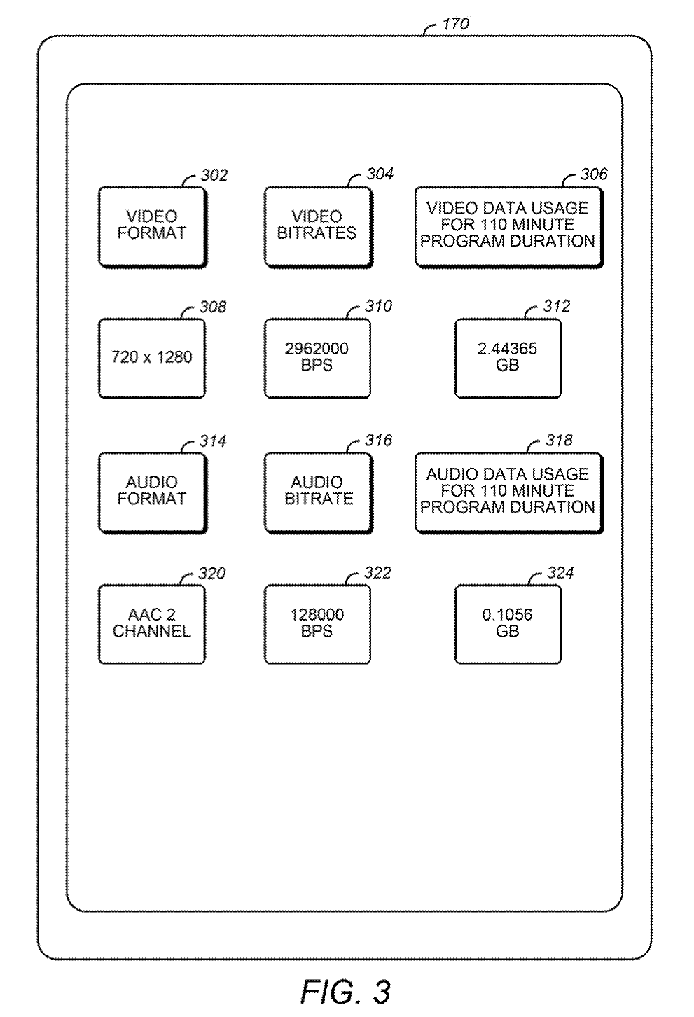

If the content is non-adaptive bit rate content (i.e., No in step 206), the process continues to step 208 and estimated data usage is displayed. FIG. 3 depicts an example of information displayed for non-adaptive bit rate content. In this example, device display 170 displays various information regarding the media content. For example, device display 170 displays a video format header field 302 with a video format value field 308; a video bitrates header field 304 with a video bitrate value field 310; and a video data usage header field 306 with a video data usage value field 312. The device display 170 also displays, for example, an audio format header field 314 with an audio format value field 320; an audio bitrate header field 316 with an audio bitrate value field 322; and an audio data usage header field 318 with an audio data usage value field 324. In the example of FIG. 3, the media content is 110 minutes in length (i.e., duration=110 minutes). Furthermore, the video format is 720×1280 with a video bit rate of 2,962,200 bps and the audio format is AAC 2 channel with an audio bit rate of 128,000 bps. Given this information, an estimate of data usage for the video is 2.44365 GB and an estimate of data usage for the audio is 0.1056 GB.

Returning to FIG. 2, content streaming begins in step 210 if the estimates are acceptable. Although not explicitly depicted, a prompt may be provided along with or as a result of the displayed estimates. The prompt is, for example, a question asking whether or not the content should be streamed given the estimated data usage. For example, a user may have a limited amount of data usage available (e.g., 500 MBs) while the requested media is estimated to require a larger amount of data usage (e.g., 1 GB), in which case the user may decline to stream the content. However, if the requested media is estimated to require less data usage (e.g., 250 MBs), the user may accept streaming of the content. If a user indicates the content is to be streamed, the content begins streaming in step 210.

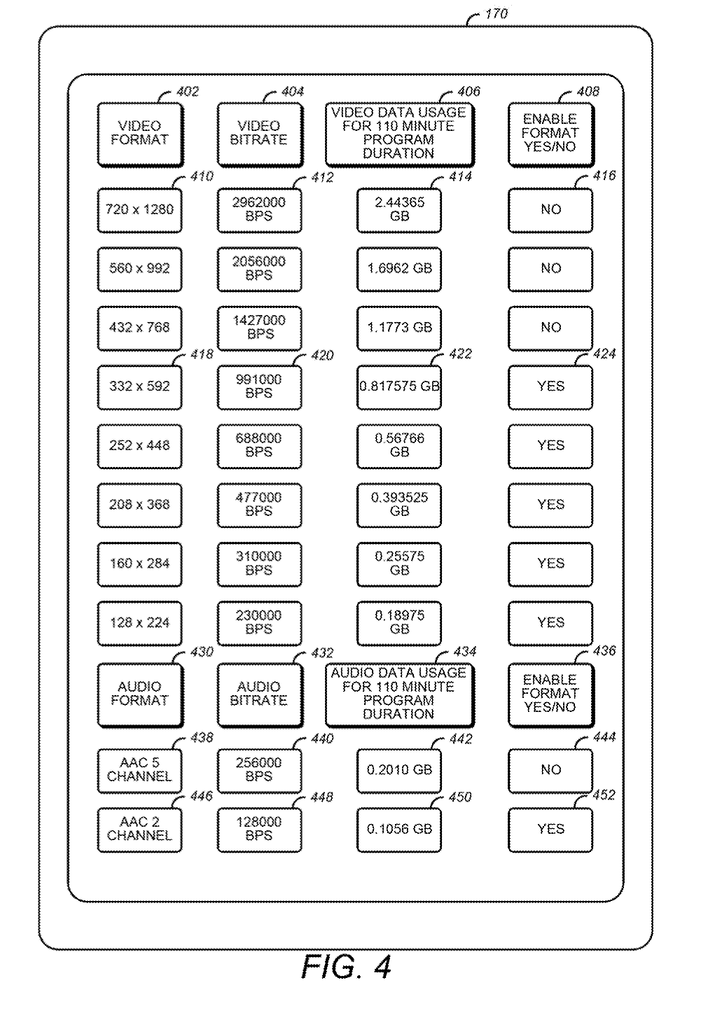

If the content is adaptive bit rate content (i.e., Yes in step 206), the process continues to step 218 and estimated data usage is displayed. FIG. 4 depicts an example of information displayed for adaptive bit rate content. In this example, device display 170 displays various information regarding the media content. For example, device display 170 displays a video format column header field 402 along with a listing of the various video formats supported by the media content, such as video format field 410 and video format field 418. A video bitrate column header field 404 is also displayed, for example, along with a listing of the various video bitrates, such as video bitrate field 412 and video bitrate field 420, corresponding to the supported video formats. The displayed information also includes, for example, a video data usage column header 406 along with estimated video data usage, such as video data usage field 414 and video data usage field 422, for each of the supported video formats and corresponding video bitrates. Furthermore, the display includes an enable format column header 408 and a user-changeable indication field, such as field 416 which indicates no and field 424 which indicates yes, for each of the supported video formats.

In addition to information related to the various supported video formats, device display 170 displays information related to various supported audio formats. For example, an audio format column header 430 is displayed along with a listing of the supported audio formats, such as audio format fields 438 and 446. An audio bitrate column header 432 is also displayed, for example, along with a listing of corresponding audio bitrates, such as audio bitrate fields 440 and 448. The display further includes, for example, an audio data usage column header 434 along with estimated audio data usage for each of the supported audio formats, such as audio data usage fields 442 and 450. The display also includes, for example, an enable format column header 436 along with a user-changeable indication field, such as fields 444 and 452, for each of the supported audio formats.

In the example of FIG. 4, the media content is 110 minutes in length (i.e., duration=110 minutes). However, the content supports various video formats and corresponding video bit rates as well as various audio formats and corresponding audio bit rates. As can be seen in the example of FIG. 4, data usage is displayed for each format and corresponding bit rate. Of note, the example depicted in FIG. 4 also includes an indication of whether a particular format and corresponding bit rate are to be enabled or otherwise selected by a user. For example, when the receiving device has a limited available data usage or a bandwidth that is limited either by the capabilities of the device or by part of the bandwidth being reserved for other features, only those formats that meet acceptable data usage and bandwidth limitations may be selected (e.g., formats with slower bit rates and/or smaller data usage). Similarly, if a user has a limited allocation of data usage, the user may only enable those bit rates that would allow the requested content to be streamed without exceeding the data usage allocation of the user. In an alternate example, a user may be one of multiple users accessing a shared network (e.g., WiFi) with limited bandwidth. In order to minimize impact on the other user(s) in this alternate example, the user may disable higher bit rates and enable or otherwise select lower bit rates that will still provide an acceptable quality for the content.

Returning to FIG. 2, content streaming begins in step 220 based on enabled formats and whether or not the estimates are acceptable. Although not explicitly depicted, a prompt may be provided along with or as a result of the displayed estimates. The prompt is, for example, a question asking whether or not the content should be streamed given the estimated data usage. Furthermore, the indication of whether a particular format and corresponding bit rate are to be enabled or otherwise selected may be user selectable. That is, the user, in one example, is able to select only those formats and corresponding bit rates that result in acceptable data usage based on the estimates. Criteria for selection of which bit rate(s) is/are to be utilized for streaming a media content include, for example, differing costs for each bit rate, download speed for each bit rate and/or media quality of each bit rate. As depicted in FIG. 4, for example, the video format of 332×592 (i.e., block 418) with video bitrate 991000 BPS (i.e., block 420) resulting in an estimated video data usage of 0.817575 GB (i.e., block 422) has been enabled with an indication of “YES” in block 424. In the same example of FIG. 4, the video format of 720×1280 (i.e., block 410) with video bitrate 296200 BPS (i.e., block 412) resulting in an estimated video data usage of 2.44365 GB (i.e., block 414) has been disabled with an indication of “NO” in block 416. As long as at least one supported format and corresponding bit rate are enabled or otherwise selected by the user, the user may decide to stream the content.

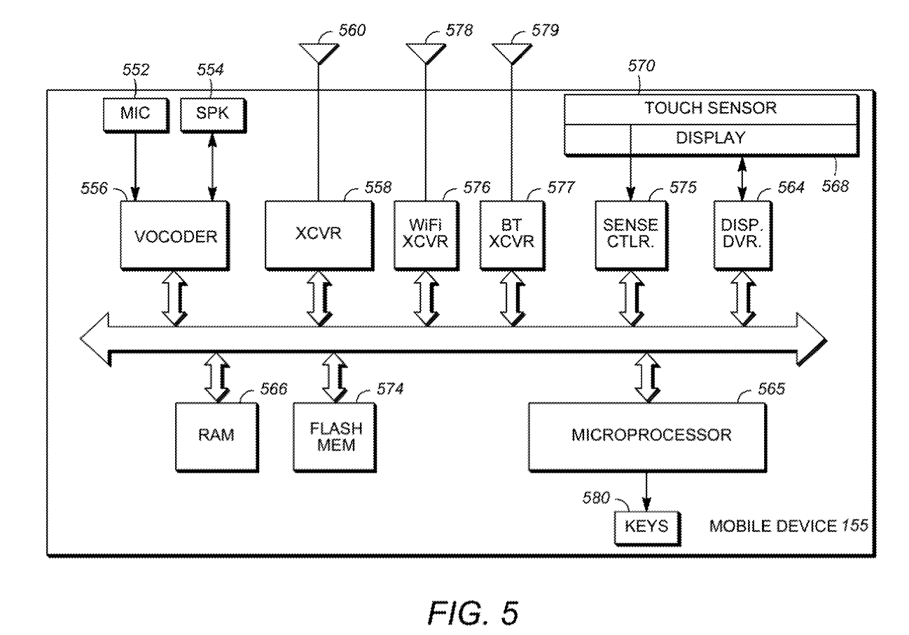

FIG. 5 is a block diagram of an example mobile device 155 that may be used as the receiving device 190 shown in FIG. 1B or the mobile device 130 shown in FIG. 1A. The mobile device includes a touch-screen display 568 for displaying application screens, messages, menus or the like and for receiving input selections such as volume settings, dialed numbers and web page navigation. A keypad 580 includes a limited number of keys that perform functions such as power-on/off, sound volume adjustments and other functions of the device.

A microprocessor 565 serves as a programmable controller for the mobile device 155 in that it controls all operations of the mobile device 155 according to programming that it executes. In the example, the mobile device 155 includes flash type program memory 574 for storage of various “software” or “firmware” such as an operating system and application programs, including the mechanism for estimated OTT media streaming data usage and data rate notification as described above. In addition, the memory 574 may hold mobile configuration settings, such as mobile directory number (MDN) and/or mobile identification number (MIN), and the like. The mobile device 155 may also include a non-volatile random access memory (RAM) 566 as working data processing memory.

The mobile device 155 further includes a microphone device 552, speaker 554 and vocoder 556 for audio input and output functions. The mobile station 155 also includes at least one digital transceiver (XCVR) 558, for digital wireless communications, such as cellular communications, and one or more short-range, wireless radio frequency transceivers 576 and 577, shown in the example as a Wi-Fi transceiver 576 and a Bluetooth (BT) or BLE transceiver 577, respectively, to communicate via a Wi-Fi channel and/or a Bluetooth channel. The transceiver 558 provides two-way wireless communication of information, such as vocoded speech samples and/or digital information, in accordance with the technology of a telecommunications network, such as a cellular network. Each example transceiver 558, 576 and 577 connects through RF to send and receive amplifiers (not separately shown) and to a respective antennas 560, 578 and 579. The transceiver 558 may also support various types of mobile messaging services, such as short message service (SMS), enhanced messaging service (EMS) and/or multimedia messaging service (MMS) and may include a web browser for interacting with websites either through the telecommunications transceiver 558 or the wireless transceiver 576. The BT transceiver 577 may interact with other Bluetooth-equipped devices, such as a wireless headset (not shown) or the like.

The user interface of the exemplary mobile device 155 includes a display 568, which the microprocessor 562 controls via a display driver 564, to present visible outputs to the device user, such as estimated data usage and/or available data rate information. The user interface also includes a touch/position sensor 570 that overlays the display 568 and is relatively transparent, so that the user may view the information presented on the display 568. A sense controller 572 senses signals from elements of the touch/position sensor 570 and detects occurrence and position of each touch of the screen formed by the display 568 and sensor 570. The sense controller 572 provides touch position information to the microprocessor 562, which can correlate that information to the information currently displayed via the display 568, to determine the nature of user input via the sensor 570.

As can be seen in the above discussion, a mechanism for estimated OTT media streaming data usage and data rate notification enables a user to make an informed decision about the content to be streamed. Based on provided estimates, the user may decide whether or not to stream the content as well as whether or not to enable one or more supported formats and corresponding bit rates. In this way, the user better understands the costs associated with the content.

While the examples have been described above in connection with specific devices, apparatus, systems, and/or methods, it is to be clearly understood that this description is made only by way of example and not as limitation. Particular embodiments, for example, may be implemented in a non-transitory computer-readable storage medium for use by or in connection with an instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented, and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. Accordingly, the specification and figures are to be regarded in an illustrative rather than a restrictive sense, and all such modifications are intended to be included within the scope of the claims. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method comprising:
obtaining meta-data associated with a multimedia asset, the meta-data describing a duration and data rate of the multimedia asset;
estimating, based on the meta-data, an amount of data usage resulting from use of at least one bit rate available for streaming the multimedia asset;
prompting a user to indicate whether to stream the multimedia asset; and
upon receipt of an indication to stream the multimedia asset, streaming the multimedia asset.

2. The method of claim 1, wherein:
the multimedia asset supports a single bit rate;
the meta-data includes an indication of a duration of the multimedia asset and an indication of the single bit rate; and
the step of prompting comprises:
displaying the duration of the multimedia asset;
displaying the indication of the single bit rate;
displaying the estimate of the amount of data usage; and
displaying a prompt requesting the user to indicate whether or not to stream the multimedia asset.

3. The method of claim 2, wherein estimating the amount of data usage comprises calculating a result of the duration of the multimedia asset multiplied by the single data rate as the estimate of the amount of data usage.

4. The method of claim 2, wherein:
the multimedia asset comprises a video portion and an audio portion;
the indication of the duration of the multimedia asset comprises an indication of a duration of the video portion and an indication of a duration of the audio portion;
estimating the amount of data usage comprises:
calculating a result of the duration of the video portion multiplied by the single bit rate as an estimate of an amount of video data usage;
calculating a result of the duration of the audio portion multiplied by the single bit rate as an estimate of an amount of audio data usage; and
calculating a result of the amount of video data usage added to the amount of audio data usage as the estimate of the amount of data usage; and
displaying the estimate of the amount of data usage comprises:
displaying the estimate of the amount of video data usage;
displaying the estimate of the amount of audio data usage; and
displaying the estimate of the amount of data usage.

5. The method of claim 1, wherein:
the multimedia asset supports a plurality of bit rates;
the meta-data includes an indication of a duration of the multimedia asset and an indication of each supported bit rate; and
the step of prompting comprises:
displaying the duration of the multimedia asset;
for each supported bit rate:
displaying the indication of the respective bit rate;
displaying the estimate of the amount of data usage resulting from use of the respective bit rate; and
displaying a prompt requesting a user to select whether or not the respective bit rate is to be available for streaming the multimedia asset; and
displaying a prompt requesting the user to indicate whether or not to stream the multimedia asset.

6. The method of claim 5, wherein estimating the amount of data usage comprises: for each supported bit rate:
calculating a result of the duration of the multimedia asset multiplied by the respective supported bit rate as the estimate of the amount of data usage resulting from use of the respective supported bit rate.

7. The method of claim 5, wherein:
the multimedia asset comprises a video portion and an audio portion;
the indication of the duration of the multimedia asset comprises an indication of a duration of the video portion and an indication of a duration of the audio portion;
estimating the amount of data usage comprises:
for each supported bit rate:
calculating a result of the duration of the video portion multiplied by the respective supported bit rate as an estimate of an amount of video data usage resulting from use of the respective supported bit rate;
calculating a result of the duration of the audio portion multiplied by the respective supported bit rate as an estimate of an amount of audio data usage resulting from use of the respective supported bit rate; and
calculating a result of the amount of video data usage resulting from use of the respective supported bit rate added to the amount of audio data usage resulting from use of the respective supported bit rate as the estimate of the amount of data usage resulting from use of the respective supported bit rate; and
displaying the estimate of the amount of data usage comprises:
for each supported bit rate:
displaying the respective estimate of the amount of video data usage;
displaying the respective estimate of the amount of audio data usage; and
displaying the respective estimate of the amount of data usage.

8. The method of claim 5, wherein streaming the multimedia asset comprises streaming the multimedia asset at only one or more of the supported bit rates selected by the user.

9. A device, comprising:
a receiver connected to receive audio and video data from a multimedia stream;
a computer memory; and
a processor in communication with the receiver and the computer memory, the processor programmed to:
obtain meta-data associated with a multimedia asset, the meta-data describing a duration and data rate of the multimedia asset;
estimate, based on the meta-data, an amount of data usage resulting from use of at least one bit rate available for streaming the multimedia asset;
prompt a user to indicate whether to stream the multimedia asset; and
upon receipt of an indication to stream the multimedia asset, stream the multimedia asset.

10. The device of claim 9, wherein:
the multimedia asset supports a single bit rate;
the meta-data includes an indication of a duration of the multimedia asset and an indication of the single bit rate; and
the processor is further programmed to:
display the duration of the multimedia asset;
display the indication of the single bit rate;
display the estimate of the amount of data usage; and
display a prompt requesting the user to indicate whether or not to stream the multimedia asset.

11. The device of claim 10, wherein the processor is programmed to estimate the amount of data usage by calculating a result of the duration of the multimedia asset multiplied by the single bit rate as the estimate of the amount of data usage.

12. The device of claim 10, wherein:
the multimedia asset comprises a video portion and an audio portion;
the indication of the duration of the multimedia asset comprises an indication of a duration of the video portion and an indication of a duration of the audio portion; and
the processor is programmed to:
calculate a result of the duration of the video portion multiplied by the single bit rate as an estimate of an amount of video data usage;
calculate a result of the duration of the audio portion multiplied by the single bit rate as an estimate of an amount of audio data usage;
calculate a result of the amount of video data usage added to the amount of audio data usage as the estimate of the amount of data usage;
display the estimate of the amount of video data usage;
display the estimate of the amount of audio data usage; and
display the estimate of the amount of data usage.

13. The device of claim 9, wherein:
the multimedia asset supports a plurality of bit rates;
the meta-data includes an indication of a duration of the multimedia asset and an indication of each supported bit rate; and
the processor is programmed to:
display the duration of the multimedia asset;
for each supported bit rate:
display the indication of the respective bit rate;
display the estimate of the amount of data usage resulting from use of the respective bit rate; and
display a prompt requesting a user to select whether or not the respective bit rate is to be available for streaming the multimedia asset; and
display a prompt requesting the user to indicate whether or not to stream the multimedia asset.

14. The device of claim 13, wherein the processor is further programmed to:
for each supported bit rate:
calculate a result of the duration of the multimedia asset multiplied by the respective supported bit rate as the estimate of the amount of data usage resulting from use of the respective supported bit rate.

15. The device of claim 13, wherein:
the multimedia asset comprises a video portion and an audio portion;
the indication of the duration of the multimedia asset comprises an indication of a duration of the video portion and an indication of a duration of the audio portion; and
the processor is programmed to:
for each supported bit rate:
calculate a result of the duration of the video portion multiplied by the respective supported bit rate as an estimate of an amount of video data usage resulting from use of the respective supported bit rate;
calculate a result of the duration of the audio portion multiplied by the respective supported bit rate as an estimate of an amount of audio data usage resulting from use of the respective supported bit rate;
calculate a result of the amount of video data usage resulting from use of the respective supported bit rate added to the amount of audio data usage resulting from use of the respective supported bit rate as the estimate of the amount of data usage resulting from use of the respective supported bit rate;
display the respective estimate of the amount of video data usage;
display the respective estimate of the amount of audio data usage; and
display the respective estimate of the amount of data usage.

16. A non-transitory computer readable medium containing computer instructions, the instructions causing a computer to:
obtain meta-data associated with a multimedia asset, the meta-data describing a duration and data rate of the multimedia asset;
estimate, based on the meta-data, an amount of data usage resulting from use of at least one bit rate available for streaming the multimedia asset;
prompt a user to indicate whether to stream the multimedia asset; and
upon receipt of an indication to stream the multimedia asset, stream the multimedia asset.

17. The computer readable medium of claim 16, wherein:
the multimedia asset supports a single bit rate;
the meta-data includes an indication of a duration of the multimedia asset and an indication of the single bit rate; and
the instructions cause the computer to:
display the duration of the multimedia asset;
display the indication of the single bit rate;
display the estimate of the amount of data usage; and
display a prompt requesting the user to indicate whether or not to stream the multimedia asset.

18. The computer readable medium of claim 17, wherein:
the multimedia asset comprises a video portion and an audio portion;
the indication of the duration of the multimedia asset comprises an indication of a duration of the video portion and an indication of a duration of the audio portion; and
the instructions cause the computer to:
calculate a result of the duration of the video portion multiplied by the single bit rate as an estimate of an amount of video data usage;
calculate a result of the duration of the audio portion multiplied by the single bit rate as an estimate of an amount of audio data usage;
calculate a result of the amount of video data usage added to the amount of audio data usage as the estimate of the amount of data usage;
display the estimate of the amount of video data usage;
display the estimate of the amount of audio data usage; and
display the estimate of the amount of data usage.

19. The computer readable medium of claim 16, wherein:
the multimedia asset supports a plurality of bit rates;
the meta-data includes an indication of a duration of the multimedia asset and an indication of each supported bit rate; and
the instructions further cause the computer to:
display the duration of the multimedia asset;
for each supported bit rate:
display the indication of the respective bit rate;
display the estimate of the amount of data usage resulting from use of the respective bit rate; and
display a prompt requesting a user to select whether or not the respective bit rate is to be available for streaming the multimedia asset; and
display a prompt requesting the user to indicate whether or not to stream the multimedia asset.

20. The computer readable medium of claim 19, wherein:
the multimedia asset comprises a video portion and an audio portion;
the indication of the duration of the multimedia asset comprises an indication of a duration of the video portion and an indication of a duration of the audio portion; and
the instructions further cause the computer to:
for each supported bit rate:
calculate a result of the duration of the video portion multiplied by the respective supported bit rate as an estimate of an amount of video data usage resulting from use of the respective supported bit rate;
calculate a result of the duration of the audio portion multiplied by the respective supported bit rate as an estimate of an amount of audio data usage resulting from use of the respective supported bit rate;
calculate a result of the amount of video data usage resulting from use of the respective supported bit rate added to the amount of audio data usage resulting from use of the respective supported bit rate as the estimate of the amount of data usage resulting from use of the respective supported bit rate;
display the respective estimate of the amount of video data usage;
display the respective estimate of the amount of audio data usage; and
display the respective estimate of the amount of data usage.
